(19) United States
(12) Patent Application Publication
(10) Pub. No.: US 2017/0076378 A1
(43) Pub. Date: Mar. 16, 2017

(54) SYSTEM FOR RESTRUCTURING BASED ON PREDICTIVE ANALYSIS

(71) Applicant: BANK OF AMERICA CORPORATION, Charlotte, NC (US)

(72) Inventors: Katherine Dintenfass, Charlotte, NC (US); Alexander C. Wittkowski, Charlotte, NC (US); Cameron Darnell Wadley, Waxhaw, NC (US); Alicia C. Jones-McFadden, Fort Mill, SC (US); Angela Fritz Thompson, Matthews, NC (US); Damon C. Missouri, Trenton, NJ (US)

(21) Appl. No.: 14/851,750

(22) Filed: Sep. 11, 2015

(51) Int. Cl. G06Q 40/06

(52) U.S. Cl. CPC G06Q 40/06

(57) ABSTRACT

Disclosed herein are systems, methods, and computer program products that predict the occurrence of a life event, such as a marriage, for a first customer, provide a plurality of account management models that the first customer may select from to restructure the assets and accounts of the first customer (and possibly a second customer also involved in the predicted life event) based on the new goals, requirements, and tax implications of the predicted life event. The systems, methods, and computer program products provided herein simplify the process of combining at least some assets and accounts of two customers, or at least restructuring the assets and accounts, to prepare the two customers for collaborative financial planning.

### FIELD OF THE INVENTION

This disclosure generally relates to a system for restructuring based on predictive analysis.

### BACKGROUND

As individuals encounter certain life events like marriage, the structure of their assets may require reorganization to accommodate new assets, new tax implications, and new financial goals. Predicting the occurrence of such life events may allow an entity to proactively configure and allocate the assets of these individuals, simplifying the account restructuring process.

### SUMMARY OF INVENTION

The following presents a summary of certain embodiments of the present invention. This summary is not intended to be a comprehensive overview of all contemplated embodiments, and is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the invention generally provide for a system that predicts the occurrence of a life event, such as a marriage, for a first customer, provides a plurality of account management models that the first customer may select from to restructure the assets and accounts of the first customer (and possibly a second customer also involved in the predicted life event) based on the new goals, requirements, and tax implications of the predicted life event. The systems, methods, and computer program products provided herein simplify the process of combining at least some assets and accounts of two customers, or at least restructuring the assets and accounts, to prepare the two customers for collaborative financial planning.

System, methods, and computer program products are described herein that provide for structuring an account based on predictive analysis. In some embodiments, the system comprises receiving a first set of customer data comprising a first customer's social media data, transaction data, search history data, and customer information, and storing the first set of customer data in a database. Additionally, the system may comprise predicting the occurrence of a life event based on the first set of customer data. In some embodiments, predicting the occurrence of the life event comprises continuously monitoring the first set of customer data and detecting a change in the first set of customer data that that suggests the occurrence of the life event. Furthermore, the system may comprise identifying account organization factors in the first set of customer data. In some embodiments, the system further comprises determining a plurality of available account management models based on the predicted occurrence of the life event and the first set of customer data. Additionally, the system may include providing a customer device to the first customer and prompting the customer device to display the plurality of available account management models. Finally, the system may comprise receiving, from the customer device, an indication that the first customer has selected a first account management model from the plurality of available account management models, and applying the first account management model to assets of the first customer.

In some embodiments of the invention, the life event comprises one of an engagement, a marriage, a wedding, a common law marriage, a civil union, or a cohabitation with another individual.

Additionally, in some embodiments, the system comprises identifying a second customer, and retrieving a second set of customer data, wherein the second set of customer data comprises the second customer's social media data, transaction data, search history data, and customer information. Furthermore, in some embodiments of the invention, the system comprises determining the plurality of available account management models based on the predicted occurrence of the life event, the first set of customer data, and the second set of customer data, and applying the first account management model to the assets of the first customer and to the assets of the second customer. In some embodiments of the invention, identifying the second customer comprises prompting the customer device of the first customer to request an identity of the second customer, wherein the second customer is associated with the predicted life event and retrieving, from the customer device, a response from the first customer comprising the identity of the second customer. Furthermore, in some embodiments of system, identifying the second customer comprises determining the identity of the second customer from the first set of customer data associated with the predicted life event.

In some embodiments of the invention, applying the first account management model to the assets of the first customer further comprises prompting the customer device to display a selectable calendar and a request for an account management model conversion date to the first customer, receiving, from the customer device, a selected account management model conversion date from the first customer, and applying the first account management model to the assets of the first customer on the selected account management model conversion date.

Finally, in some embodiments of the invention, the account organization factors associated with the customer data comprise information related to how the first customer's assets can be allocated, and wherein the account organization factors include at least one of an account balance, an amount of debt associated with an account, an age of the first customer, dependents of the first customer, geographic location of the first customer, and tax implications of every available account type.

To the accomplishment of the foregoing and related objectives, the embodiments of the present invention comprise the function and features hereinafter described. The following description and the referenced figures set forth a detailed description of the present invention, including certain illustrative examples of the one or more embodiments. The functions and features described herein are indicative, however, of but a few of the various ways in which the principles of the present invention may be implemented and used and, thus, this description is intended to include all such embodiments and their equivalents.

The features, functions, and advantages that have been discussed may be achieved independently in various embodiments of the invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a general process flow for structuring accounts based on predictive analysis, in accordance with an embodiment of the invention;

FIG. 2 is a general process flow for structuring accounts or two customers based on predictive analysis, in accordance with an embodiment of the invention; and

FIG. 3 is a block diagram of a system environment for restructuring accounts based on predictive analysis, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, and the like, and/or may not include all of the devices, components, modules, and the like, discussed in connection with the figures. A combination of these approaches may also be used.

The steps and/or actions of a method or algorithm described in connection with the embodiments disclosed herein may be embodied directly in hardware, in one or more software modules (also referred to herein as computer-readable code portions) executed by a processor or processing device and configured for performing certain functions, or in a combination of the two. A software module may reside in RAM memory, flash memory, ROM memory, EPROM memory, EEPROM memory, registers, a hard disk, a removable disk, a CD-ROM, or any other form of non-transitory storage medium known in the art. An exemplary storage medium may be coupled to the processing device, such that the processing device can read information from, and write information to, the storage medium. In the alternative, the storage medium may be integral to the processing device. Further, in some embodiments, the processing device and the storage medium may reside in an Application Specific Integrated Circuit (ASIC). In the alternative, the processing device and the storage medium may reside as discrete components in a computing device. Additionally, in some embodiments, the events and/or actions of a method or algorithm may reside as one or any combination or set of codes or code portions and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions, code, or code portions on a computer-readable medium. Computer-readable media includes both non-transitory computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Thus, systems, methods, and computer program products are described herein that provide for a system for restructuring accounts based on predictive analysis.

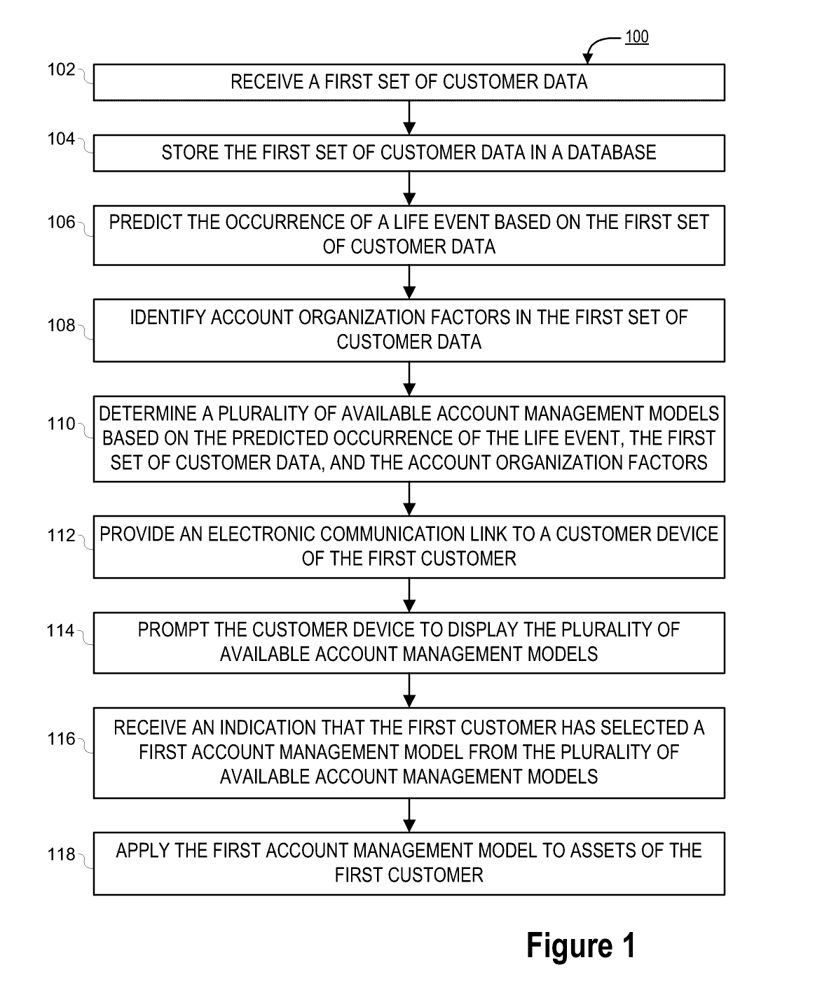

FIG. 1 displays a general process flow 100 for structuring accounts based on predictive analysis, according to embodiments of the invention. In general, the process 100 includes receiving information associated with a first customer, monitoring this information for data that suggests that a life event (such as an engagement, a marriage, or a civil union) will occur, creating multiple account management models based on the customer information, and restructuring the first customer's accounts and assets based on the account management model selected by the first customer.

The process 100 includes the block 102 of receiving a first set of customer data. As used herein, the term “customer data” refers to the social media data, transaction data, search history data, and customer information of a customer associated with the entity providing the system for restructuring accounts based on predictive analysis. Customer information may be any biographical information associated with a customer including, but not limited to, name, age, geographical location, residency, employment, relationship status, family status, family members, number of dependents, financial account information, financial goals, and the like. Social media data may be any information associated with a customer that relates to their use of a social or networking website, and includes, but is not limited to, social media names or handles, friends, followers, social media accounts that the customer is following, relationship status inputs, and the like. Search history data may be any information related to a customer's use of a web browser either associated with the entity or not, and includes, but is not limited to, query terms searched, websites visited, items purchased online, and the like. Transaction data may be any information associated with a customer's financial accounts and transactions, and may include, but is not limited to, account names, account information, account ownership, merchants that the customer has purchased from, items purchased by the customer, and the like.

The process 100 may further include block 104, wherein the system stores the first set of customer data in a database. The customer data may be stored in such a manner that the system may quickly parse through the database to identify specific customer data. In some embodiments, the system receives and stores the customer information as soon as it is made available. Likewise, in some embodiments, the system continuously monitors at least some aspects of the customer data for changes in the customer data. As such, the system may replace the changed customer data with the new customer data. In some embodiments, the system continues to store customer data that has changed, and may provide one or more time stamps indicating when the customer data was first acquired and when it was replaced by newer customer data. For example, while if the system first identifies from a customer's social media data that the customer has a relationship status as “single” at a first point in time, but later determines that the customer changes the relationship status to “engaged” at a second point in time, the system may continue to store the “single” status and associate this older status with the first and second time points.

Additionally, the process 100 may include block 106, wherein the system predicts the occurrence of a life event based on the first set of customer data. As used herein, a “life event” may be any occasion that brings two individuals together such that the two individuals may desire to combine bank accounts. These life events may be ceremonial, legal, or practical in nature. Examples of life events includes, but is not limited to, engagements, marriages, common law marriages, moving into the same dwelling, adopting a child together, moving a parent into the home, starting a joint venture, and the like.

When two individuals encounter a life event, they may desire to combine or reorganize at least some of their individual financial accounts, asset ownership, and beneficiary statuses as a result of tax, legal, or practical factors. For example, two individuals that plan to get married may benefit from combining each of their individual checking accounts into a single, shared, checking account for practical purposes. Additionally, one of the two individuals planning to get married may desire to change a named beneficiary of a trust account held by that individual upon marriage to the other individual. In general, life events tend to induce a desire to reorganize accounts of one or both individuals due to changes in savings plans, investment plans, tax implications, new income, new debts, new responsibilities, and other factors that are created by the occurrence of the life event.

The system may predict the occurrence of a life event by identifying a change in the customer data associated with a first customer's relationship status, a purchase associated with a marriage, a search query directed to a marriage, customer information changes indicating marriage, and the like. For example, the system may monitor the first customer's social media data for changes in the first customer's relationship status indicating an engagement, or marriage. In some embodiments, the system may determine that the first customer has opened a social media or other account with a website for linking and displaying wedding registries and wedding venue information.

Alternatively or additionally, the system may monitor the first customer's transaction data for transaction data changes or new transaction data associated with a life event such as a marriage or an engagement. Examples of transaction data associated with a life event include purchases of a diamond, a ring, a wedding cake, a wedding dress, reservation of a wedding venue, wedding invitation cards, wedding planner services, a house, a condominium, a rental of an apartment, and the like. Alternatively or additionally, the system may monitor the first customer's search query data for search query data associated with a marriage or an engagement. Examples of search query data associated with a life event include search terms of diamonds, engagement rings, wedding cakes, wedding dresses, wedding venues, weddings, engagements, proposals, bachelor parties, bachelorette parties, engagement parties, wedding invitations, wedding planners, honeymoon destinations, houses, condominiums, cohabitation, moving in together, husband, wife, spouse, and the like. In some embodiments, the ages of cohabitants in a house or apartment may be identified to compare with the age of the first customer as an indication of a possible relationship between the two individuals that may benefit from the system's asset and account restructuring features.

In some embodiments, the system uses a single change in customer data as a trigger for indicating or predicting the occurrence of a life event. For example, determining that the first customer has purchased an engagement ring can be a trigger to the system indicating the likelihood of the occurrence of a marriage in the future. In some embodiments, the system may use multiple changes in customer data as a trigger for indicating or predicting the occurrence of a life event. For example, determining that the first customer is in a relationship with a second customer and determining that the first customer has made a down payment on a house may be a trigger for indicating the likelihood of the occurrence of a cohabitation life event now or in the future. Of course, the system may be configured to have multiple triggers, wherein each trigger is a single change or addition in customer data or a change or addition in multiple customer data components.

In some embodiments, the system may monitor the customer information over time. By monitoring over time, the system may identify triggering events as they occur and determine trends in customer data. For example, the system may track the assets and accounts of the first customer over time, determine a trend of the first customer's assets are leaving the entity's system for another system. The system may be configured to identify this trend as a triggering event for an indication that the customer may be joining accounts with a spouse or other individual at another entity, and therefore likely interested in restructuring the accounts. By identifying this trend as a triggering event, the system may help the first customer restructure the accounts currently held with the entity and possibly bring in one or more accounts currently being held by another entity.

In some embodiments, the entity receives customer information associated with the first customer's accounts and assets managed by the entity. In such embodiments, the system may monitor changes in the first customer's relationship status, the names and identities of dependents associated with the first customer, the name and identity of a spouse of the first customer, the names and identities of beneficiaries to one or more accounts owned by the first customer, as well as biographical information of the first customer such as changes to the last name of the customer, changes in a residential address of the first customer, and the like. In some embodiments, the system may pull customer information from one or more external systems such as a social media system, a public records system, an external entity system, customer input, and the like.

In some embodiments, the process 100 may further include block 108, wherein the system identifies account organization factors in the first set of customer data. As used herein, “account organization factors” are items, relationships, statuses, financial goals, and the like that may be taken into account when determining how a customer could, or should, organize their assets. Examples of account organization factors include spending amounts (e.g., monthly spending, annual spending, and the like), periodic payments (e.g., rent payments, tuition, debt payments, insurance payments, and the like), income (e.g., employment income, annuity income, and the like), dependents, financial goals, beneficiary goals, large assets (e.g., automobile, boat, recreational vehicle, and the like), investment goals, investment vehicles, and the like. In some embodiments of the invention, the account organization factors may be based one or more accounts associated with at least two individuals. For example, if a first customer and a second customer are planning to get married, the system may review accounts associated with both the first and the second customers and identify organization factors that affect the account organizations of both the first and second customers. Examples of account organization factors that affect multiple customers include the previously mentioned account organization factors as well as the following factors: cumulative income, cumulative debt, tax implications associated with marriage, customer interests in sharing at least some assets, customer interests in not sharing at least some assets, and the like.

In some embodiments, the system may request input from one or both of the customers, possibly via an electronic communication link with a customer device, wherein the request may be for organization factors that are important to a customer, important to both customers, or organization factors that are not immediately identifiable from the customer data. In some embodiments, the customer device is a first customer device associated with the first customer. In some embodiments, the customer device is a second customer device associated with the second customer. In some embodiments, both customers may access the same customer device, and therefore the first customer device and the second customer device are in fact the same device.

Furthermore, in some embodiments of the invention, the process 100 includes block 110, wherein the system determines a plurality of available account management models based on the predicted occurrence of the life event, the first set of customer data, and the account organization factors. As used herein, “account management models” are organizational structures for maintaining accounts, assets, and the like of customers. A single account management model may comprise a single financial account, such as a checking account. In some embodiments, a single account management model may comprise multiple financial accounts, such as a checking account and a savings account. In some embodiments, a single account management model may comprise multiple financial accounts, wherein each financial account is associated with one or more customers or individuals. For example, a first financial account model may comprise a checking account associated with a first customer, a checking account associated with a second customer, and a savings account associated with both the first customer and the second customer.

In some embodiments, a single account management model may comprise financial accounts and/or investment vehicles such as bonds, certificates of deposit (CDs), mutual funds, exchange-traded funds (ETFs), stocks, options, futures, real estate, interest in a corporation or partnership, and the like.

In some embodiments, the system may determine every possible account management model for a customer, or the customer and another individual, based on the specific life event predicted, the first set of customer data (especially data associated with financial accounts and investment data), and the account organization factors. In some embodiments, the system may have a few template account management models that may be populated with the financial information of the first customer and organized based on the account organization factors associated with the first customer. For example, if the system predicts that a first customer will marry a second customer, the system may automatically suggest (1) a first account management model of a checking account for the first customer, a checking account for a second customer, and a savings account for both the first and second customer; (2) a second account management model of a checking account for both the first and second customer, and a savings account for both the first and second customer; and (3) a third account management model of a checking account for the first customer, a savings account for the first customer, checking account for the second customer, and a savings account for the second customer. While the above example only uses ownership of checking and savings accounts as the basis for an account management model, other embodiments of the invention may use other financial accounts or investment vehicles in the account management models, as well as other restrictions to the accounts and/or asset ownership. For example, an account management model may comprise specific beneficiaries for certain financial accounts or investment vehicles, place access restrictions or limitations on the first or second customer for at least one financial account or asset, and the like.

In some embodiments, the process 100 includes block 112, wherein the system provides an electronic communication link to a customer device of the first customer. As used herein, a “customer device” is an electronic device that may communicate other network system via the network, and includes input and output mechanisms for such communication. For example, a customer device may be a mobile device, a computer, a tablet, a smart watch or other wearable, and the like. In some embodiments, the output mechanism of the customer device comprises a graphical user interface (GUI) for displaying information to the customer. Likewise, in some embodiments, the input mechanism of the customer device may comprise a touchscreen, a keypad, a mouse, or other input device capable of selecting or entering information into the customer device such that the customer device may transmit the input information to other systems in the system environment via the network.

In some embodiments, the electronic communication link is a secure connection channel between the entity system and the customer device that provides additional data security to the data and information communicated between the customer device and the system. In such embodiments, the electronic communication link may separate data communicate between the entity system and the customer device as part of the process 100 from normal data communication for regular transactions or general communication. Securing the communication data associated with account organization may be important to customers of the entity and therefore may require such enhanced security measures.

In some embodiments, the process 100 may include block 114, wherein the system prompts the customer device to display the plurality of available account management models. In some embodiments, the system may provide a list of available account management models to the first customer via a display on the customer device. The display may include a name for each account management model, a description for each account management model, and any additional steps or other requirements for the customer to be aware of if they decide to select each account management model.

In some embodiments, the system may further prompt the customer device to display one or more questions regarding customer data, especially account organization factors. For example, the system may be able to provide an additional account management model if the first customer provides information associated with one or more accounts held by a third entity that the customer is willing to transfer to the operating entity upon selection of a desired account management model from the system. Upon receiving a response from the first customer, the system may re-determine the account management models to be displayed to the customer. In some embodiments, the system may display account management models that may be customized by the customer via the customer device. For example, each account management model may comprise at least two accounts, and an asset value associated with each account. The first customer may then change the distribution of assets between the at least two accounts (e.g., with a slide bar, by manually inputting the amounts, and the like), manipulating and customizing the available account management model that is presented to the customer.

Furthermore, in some embodiments, the process 100 may include block 116, wherein the system receives an indication that the first customer has selected a first account management model from the plurality of available account management models. In some embodiments, this indication is received at the customer device, via the customer device input, and communicated to the entity system via the network. In some embodiments, the system receives the customer selections via a secured communication link between the customer device and the entity system. The first customer's selection of a first account management model may be an authorization to restructure the assets and accounts associated with the first customer into the first account management model structure. In embodiments where a second customer's assets are included in the first account management model, the system may request, and receive authorization from the second customer in addition to the selection from the first customer.

In some embodiments, the process 100 may include block 118, wherein the system applies the first account management model to assets of the first customer. In some embodiments, the system reorganizes the assets of the first customer into the selected account management model as soon as the system receives the selection from the customer. In some embodiments, the system does not transfer the assets of the first customer into the selected account management model until a later date (e.g., upon the actual occurrence of the life event). For example, the system may prompt the customer device do display a selectable calendar to the customer and display a request for the customer to select a conversion date. Upon receiving the customer selected conversion date, the system may maintain the current account organizational structure until the selected conversion data, at which time the system will then convert the accounts and assets of the first customer into the selected account management model.

In embodiments wherein at least one account or asset is associated with another entity, the system may further comprise transferring the at least one account or asset from the other entity to the operating entity. In some embodiments, the system may request authorization from the first customer to transfer the at least one account or asset to the operating entity, wherein the authorization request may require a signature, a release, or other document.

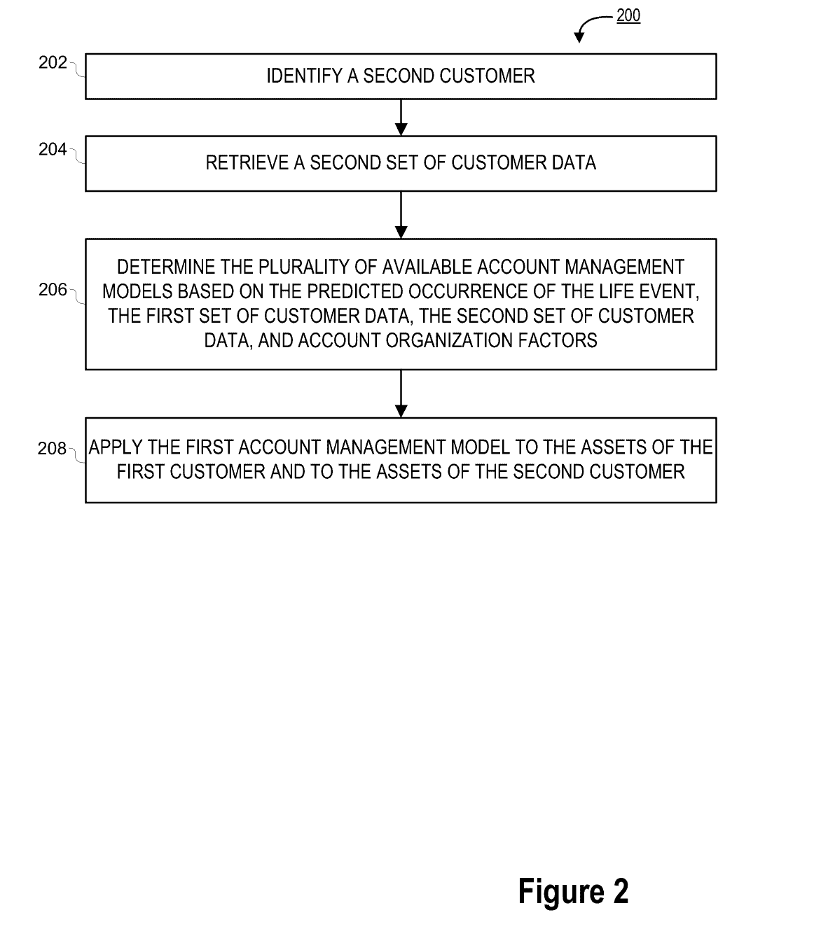

Turning now to FIG. 2, a general process flow 200 is provided for restructuring accounts of a first and second customer based on predictive analysis, according to one embodiment of the invention. Embodiments of this process 200 may be used in conjunction with one or more concepts described for process 100. The process 200 generally acts to identify a second customer associated with the life event of the first customer (e.g., a future spouse), retrieve customer data associated with the second customer, make the available account management models based on the first customer data, the second customer data, the predicted life event, and the account organization factors, and restructure accounts associated with both the first customer and the second customer into a selected account management model. Such a process 200 may allow an entity to take the assets and accounts associated with two customers that are engaged to be married, provide selectable account configurations for when the two customers are married, and ultimately reconfigure the accounts and assets into a desired account management organization based on the occurrence of the marriage.

The process 200 may include block 202, wherein the system identifies a second customer. In some embodiments, the second customer is named or otherwise identified in the first customer data. For example, the system may have identified a change in the first customer's social media data indicating that the first customer is now engaged with the second customer. In some embodiments, the system may prompt the customer device associated with the first customer to display a request for an identity of the second customer, wherein the second customer is a second individual that will be encountering the life event along with the first customer. In such embodiments, the system may then receive a response from the first customer indicating the identity of the second customer.

In some embodiments, the process 200 includes block 204, wherein the system retrieves a second set of customer data. In some embodiments, the second customer is a customer of the entity operating the process 200, and as such, the entity may be able to retrieve at least some customer data associated with the second customer from a customer profile database. In other embodiments, the second customer may have at least one account or asset associated with a third entity. In such embodiments, the system may request and receive information associated with the second customer's accounts that are currently managed by another entity. As with the first customer, the system may access one or more databases that store information related to the second customer's interaction with social media websites, online search queries, personal information, and transaction information.

Again, the term “customer data” refers to the social media data, transaction data, search history data, and customer information of a customer associated with the entity providing the system for restructuring accounts based on predictive analysis. Customer information may be any biographical information associated with a customer including, but not limited to, name, age, geographical location, residency, employment, relationship status, family status, family members, number of dependents, financial account information, financial goals, and the like. Social media data may be any information associated with a customer that relates to their use of a social or networking website, and includes, but is not limited to, social media names or handles, friends, followers, social media accounts that the customer is following, relationship status inputs, and the like. Search history data may be any information related to a customer's use of a web browser either associated with the entity or not, and includes, but is not limited to, query terms searched, websites visited, items purchased online, and the like. Transaction data may be any information associated with a customer's financial accounts and transactions, and may include, but is not limited to, account names, account information, account ownership, merchants that the customer has purchased from, items purchased by the customer, and the like.

Additionally, in some embodiments, the process 200 may include block 206, wherein the system determines the plurality of available account management models based on the predicted occurrence of the life event, the first set of customer data, the second set of customer data, and the account organization factors. In some embodiments, the system identifies account organization factors in the accounts, assets, and customer information of the second customer along with the account organization factors of the first customer. As such, the system may better determine a plurality of available account management models than by simply accounting for account organization factors of just the first customer. As with the first customer, the system may request more information from the second customer related to the account organization factors. To accomplish such objectives, the system may provide a second electronic communication link between a second customer device associated with the second customer and the entity system.

In some embodiments, the system may display the available account management models to both the first customer and the second customer, providing information about each account management model and allowing for customer selection and/or customization of one of the plurality of available account management models.

The system may then receive a selection for a first account management model from one or both of the first and second customers, indicating an authorization by both the first and second customers to restructure the respective accounts into the structure of the selected account management model. In some embodiments, the system only receives an account management model selection from one of the first or second customers. In such embodiments, the system may prompt the customer device of the other customer to display a confirmation request. The system may then receive a confirmation selection from the other customer and therefore determine that the first and second customers are in agreement and authorize the reorganization of at least some of their collective assets into the selected account management model.

In some embodiments, one or both of the first and second customer may decide to only restructure a portion of their accounts and/or assets with the other customer. In such embodiments, such a customer may input such a restriction when prompted by the system to provide additional account organization factors. In other embodiments, a customer may select a first account management model, but indicate in the selection response that the customer only authorizes the transfer or restructuring of only a portion of its accounts and/or assets. In some embodiments, at least one of the account management models may account for a customer's desire to keep at least a portion of its assets separated from the other customer's assets. In such embodiments, the system may provide one or more account management models with one or more accounts that are only accessible to one of the two customers. In this manner, the system may allow for each individual customer to maintain at least one separate account while also maintaining a jointly-owned account or asset.

Furthermore, in some embodiments, the process 200 includes block 208, wherein the system applies the first account management model to the assets of the first customer and to the assets of the second customer. In some embodiments, the system reorganizes the assets of the first and second customers into the selected account management model as soon as the system receives the selection from the customer. In some embodiments, the system does not transfer the assets of the first customer into the selected account management model until a later date (e.g., upon the actual occurrence of the life event). For example, the system may prompt the first and/or second customer device do display a selectable calendar to the customer and display a request for the customer to select a conversion date. Upon receiving the customer selected conversion date, the system may maintain the current account organizational structure until the selected conversion date, at which time the system will then convert the accounts and assets of the first and second customers into the selected account management model.

In embodiments wherein at least one account or asset is associated with another entity, the system may further comprise transferring the at least one account or asset from the other entity to the operating entity. In some embodiments, the system may request authorization from the first customer to transfer the at least one account or asset to the operating entity, wherein the authorization request may require a signature, a release, or other document.

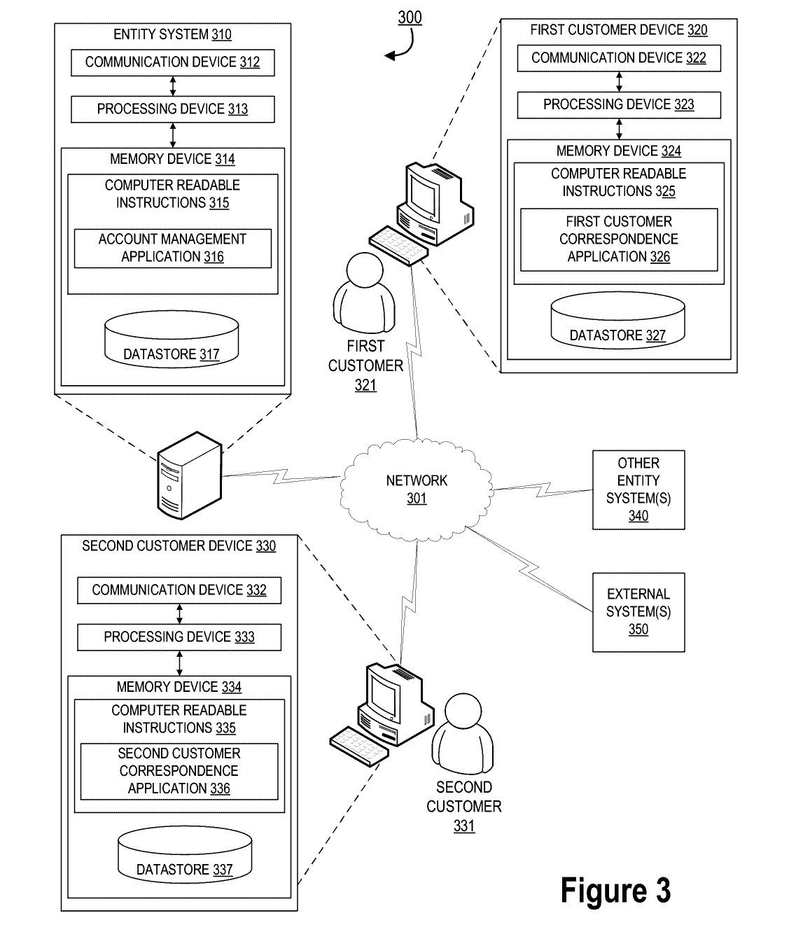

Referring now to FIG. 3, a block diagram of a system environment 300 is provided, which includes an entity system 310, a first customer system 320 associated with a first customer 321, a second customer system 330 associated with a second customer 331, one or more third party systems 340, one or more external systems 350, and a network 301.

A “system environment,” as used herein, may refer to any information technology platform of an enterprise (e.g., a national or multi-national corporation), and may include a multitude of servers, machines, mainframes, personal computers, network devices, front and back end systems, database systems, and/or the like.

An “entity,” as used herein, refers to any business or non-business units, including financial institutions, companies that produce and/or provide goods and/or services, companies that sell, offer for sale, distribute, trade, and/or otherwise deal in goods and/or services, government sponsored sectors, or government funded institutes, projects, services, and so on. A “financial institution” may refer to any organization in the business of moving, investing or lending money, dealing in financial instruments, or providing financial services. For example, a financial institute may be a commercial bank, federal and state savings bank, savings and loan association, credit union, an investment company, an insurance company, or the like.

In the system environment 300 shown in FIG. 3, the entity system 310 includes a communication device 312, at least one processing device 313, and at least one memory device 314. The memory device 314 includes computer readable instructions 315 including an account management application 316, and a datastore 317. The processing device 313 is operatively coupled to the memory device 314 and configured to execute the account management application 316 embedded in the computer readable instructions 315. The datastore 317 may contain account and asset data, social media data, search history data, and transaction data associated with one or more customers of the entity.

The first customer device 320 can be a personal computer, electronic notebook, mobile device, or any computing device that has networking capability and is in communication with the entity system 310 through the network 301. The first customer device 320 is associated with a first customer 321, such that the first customer 321 may receive outputs from, and provide inputs into, the first customer device 320. In some embodiments, the customer device 320 includes a communication device 322, at least one processing device 323, and at least one memory device 324. The memory device 324 includes computer readable instructions 325 including a first customer correspondence application 326, and a datastore 327. The first customer device 320 is operated and managed by the first customer 321.

The second customer device 330 can be a personal computer, electronic notebook, mobile device, or any computing device that has networking capability and is in communication with the entity system 310 through the network 301. The second customer device 330 is associated with a second customer 331, such that the second customer 331 may receive outputs from, and provide inputs into, the second customer device 330. In some embodiments, the customer device 330 includes a communication device 332, at least one processing device 333, and at least one memory device 334. The memory device 334 includes computer readable instructions 335 including a second customer correspondence application 336, and a datastore 337. The second customer device 330 is operated and managed by the second customer 331.

The other entity systems 340 are systems owned and/or operated by entities other than the entity that owns or controls the entity system 310. These other entity systems 340 may include communication devices, processing devices, datastores, and the like with similar information to the entity system 310, and such information may be transmitted to the entity system 310, the first customer device 320, the second customer device 330, and/or the external systems 350 via the network 301. In some embodiments, the other entity system 340 comprises a financial institution associated with one or more accounts owned or managed by the first customer 321 and/or the second customer 331.

The external systems 350 may comprise any other systems accessible by the entity system 310, the first customer device 320, the second customer system 330, and/or the third party systems 340. In some embodiments, the external systems comprise social media systems, investment vehicle systems, real estate management systems, and the like.

The processing devices 313, 323, and 333 are operatively coupled to the communication devices 312, 322, and 332 and the memory devices 314, 324, and 334. The processing devices 313, 323, and 333 use the communication devices 312, 322, and 332 to communicate with the network 301 and other devices on the network 301, such as, but not limited to, the entity system 310, the first customer device 320, the second customer device 330, the other entity systems 340, the external systems 350, and/or other systems. As such, the communication devices 312, 322, and 332 generally comprise a modem, server, or other device for communicating with other devices on the network 301 and/or a keypad, keyboard, touchscreen, touchpad, display, microphone, mouse, joystick, other pointer device, button, soft key, and/or other input and/or output device(s) for communicating with the first customer 321 and the second customer 331.

In some embodiments, the memory devices 314, 324, and 334 include volatile memory, such as RAM having a cache area for the temporary storage of information. The memory devices 314, 324, and 334 may also include non-volatile memory that may be embedded and/or removable. The non-volatile memory may additionally or alternatively include an Electrically Erasable Programmable Read-Only Memory (EEPROM), flash memory, and/or the like. The memory devices 314, 324, and 334 may store any information and data that are used and administrated by the entity system 310 to implement the functions thereof.

The entity system 310, the first customer device 320, the second customer device 330, the other entity systems 340, and the external systems 350 are each operatively connected to the network 301 and in communication with one another there through. The network 301 can include various networking interfaces, such as a local area network (LAN), a wide area network (WAN), a global area network (GAN), such as Internet, or a hybrid thereof. The network 301 may be secure or unsecure and may also include wireless and/or wireline and/or optical interconnection technology. Each of the entity system 310, the first customer device 320, the second customer device 330, the other entity systems 340, and the external systems 350, may all be similar or the same devices as described above with respect to the entity system 310.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise. In this regard, the term “processor” and “processing device” are terms that are intended to be used interchangeably herein and features and functionality assigned to a processor or processing device of one embodiment are intended to be applicable to or utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | | | |
|---|---|---|---|
| Docket Number | U.S. patent application Ser. No. | Title | Filed On |

| | | |
|---|---|---|
| 6811US1.014033.2512 | UNIVERSAL TOKENIZATION | Concurrently |
| | SYSTEM | Herewith |
| 6812US1.014033.2513 | SYSTEM FOR MODELING | Concurrently |
| | AND IMPLEMENTING EVENT- | Herewith |
| | RESPONSIVE RESOURCE | |
| | ALLOCATION STRUCTURES | |
| 6813US1.014033.2514 | SYSTEM FOR SIMULATION | Concurrently |
| | AND IMPLEMENTATION OF | Herewith |
| | DYNAMIC STATE- | |
| | DEPENDENT RESOURCE | |
| | RECONFIGURATION | |
| 6815US1.014033.2515 | SYSTEM FOR DYNAMIC | Concurrently |
| | VISUALIZATION OF | Herewith |
| | INDIVIDUALIZED | |
| | CONSUMPTION ACROSS | |
| | SHARED RESOURCE | |
| | ALLOCATION STRUCTURE | |
| 6817US1.014033.2516 | SYSTEM FOR ANALYZING | Concurrently |
| | PRE-EVENT AND POST- | Herewith |
| | EVENT INDIVIDUAL | |
| | ACCOUNTS AND | |
| | TRANSFORMING THE | |
| | ACCOUNTS | |
| 6818US1.014033.2517 | SYSTEM FOR OPENING AND | Concurrently |
| | CONSOLIDATING ACCOUNTS | Herewith |
| | BASED ON AN EVENT | |
| | ASSOCIATED WITH THE | |
| | ACCOUNT HOLDER | |

What is claimed is:

1. A system for structuring an account based on predictive analysis, said system comprising:
one or more memory devices having computer readable program code stored thereon; and
one or more processing device operatively coupled to the one or more memory devices, wherein the one or more processing devices are configured to execute the computer readable program code to:
receive a first set of customer data comprising a first customer's social media data, transaction data, search history data, and customer information;
store the first set of customer data in a database;
predict the occurrence of a life event based on the first set of customer data, wherein the occurrence of the life event comprises:
continuously monitoring the first set of customer data; and
detecting a change in the first set of customer data that suggests the occurrence of the life event;
identify account organization factors in the first set of customer data;
determine a plurality of available account management models based on the predicted occurrence of the life event and the first set of customer data;
provide an electronic communication link to a customer device of the first customer;
prompt the customer device to display the plurality of available account management models;
receive, from the customer device, an indication that the first customer has selected a first account management model from the plurality of available account management models; and
apply the first account management model to assets of the first customer.

2. The system of claim 1, wherein the life event comprises one of an engagement, a marriage, a wedding, a common law marriage, or a cohabitation with another individual.

3. The system of claim 1, wherein the one or more processing devices are further configured to execute the computer readable program code to:
identify a second customer;
retrieve a second set of customer data, wherein the second set of customer data comprises the second customer's social media data, transaction data, search history data, and customer information;
determine the plurality of available account management models based on the predicted occurrence of the life event, the first set of customer data, and the second set of customer data; and
apply the first account management model to the assets of the first customer and to assets of the second customer.

4. The system of claim 3, wherein identifying the second customer comprises:
prompting the customer device of the first customer to request an identity of the second customer, wherein the second customer is associated with the predicted life event; and
receiving, from the customer device, a response from the first customer comprising the identity of the second customer.

5. The system of claim 3, wherein identifying the second customer comprises determining the identity of the second customer from the first set of customer data associated with the predicted life event.

6. The system of claim 1, wherein applying the first account management model to the assets of the first customer further comprises:
prompting the customer device to display a selectable calendar and a request for an account management model conversion date to the first customer;
receiving, from the customer device, a selected account management model conversion date from the first customer; and
apply the first account management model to the assets of the first customer on the selected account management model conversion date.

7. The system of claim 1, wherein the account organization factors associated with the customer data comprise information related to how the first customer's assets can be allocated, and wherein the account organization factors include at least one of an account balance, an amount of debt associated with an account, an age of the first customer, dependents of the first customer, geographic location of the first customer, and tax implications of every available account type.

8. A computer program product for structuring an account based on predictive analysis, the computer program product comprising a non-transitory computer readable medium comprising computer readable instructions, the instructions comprising instructions for:
receiving a first set of customer data comprising a first customer's social media data, transaction data, search history data, and customer information;
storing the first set of customer data in a database;
predicting the occurrence of a life event based on the first set of customer data, wherein the occurrence of the life event comprises:
continuously monitoring the first set of customer data; and
detecting a change in the first set of customer data that that suggests the occurrence of the life event;
identifying account organization factors in the first set of customer data;
determining a plurality of available account management models based on the predicted occurrence of the life event and the first set of customer data;
providing an electronic communication link to a customer device of the first customer;
prompting the customer device to display the plurality of available account management models;
receiving, from the customer device, an indication that the first customer has selected a first account management model from the plurality of available account management models; and
applying the first account management model to assets of the first customer.

9. The computer program product of claim 8, wherein the life event comprises one of an engagement, a marriage, a wedding, a common law marriage, or a cohabitation with another individual.

10. The computer program product of claim 8, wherein the computer readable instructions further comprise instructions for:
identifying a second customer;
retrieving a second set of customer data, wherein the second set of customer data comprises the second customer's social media data, transaction data, search history data, and customer information;
determining the plurality of available account management models based on the predicted occurrence of the life event, the first set of customer data, and the second set of customer data; and
applying the first account management model to the assets of the first customer and to the assets of the second customer.

11. The computer program product of claim 10, wherein identifying the second customer comprises:
prompting the customer device of the first customer to request an identity of the second customer, wherein the second customer is associated with the predicted life event; and
retrieving, from the customer device, a response from the first customer comprising the identity of the second customer.

12. The computer program product of claim 10, wherein identifying the second customer comprises determining the identity of the second customer from the first set of customer data associated with the predicted life event.

13. The computer program product of claim 8, wherein applying the first account management model to the assets of the first customer further comprises:
prompting the customer device to display a selectable calendar and a request for an account management model conversion date to the first customer;
receiving, from the customer device, a selected account management model conversion date from the first customer; and
applying the first account management model to the assets of the first customer on the selected account management model conversion date.

14. The system of claim 8, wherein the account organization factors associated with the customer data comprise information related to how the first customer's assets can be allocated, and wherein the account organization factors include at least one of an account balance, an amount of debt associated with an account, an age of the first customer, dependents of the first customer, geographic location of the first customer, and tax implications of every available account type.

15. A computer implemented method for structuring an account based on predictive analysis, said computer implemented method comprising:
receiving, via a processing device, a first set of customer data comprising a first customer's social media data, transaction data, search history data, and customer information;
storing, via a processing device, the first set of customer data in a database;
predicting, via a processing device, the occurrence of a life event based on the first set of customer data, wherein the occurrence of the life event comprises:
continuously monitoring the first set of customer data; and
detecting a change in the first set of customer data that that suggests the occurrence of the life event;
identifying, via a processing device, account organization factors in the first set of customer data;
determining, via a processing device, a plurality of available account management models based on the predicted occurrence of the life event and the first set of customer data;
providing, via a processing device, an electronic communication link to a customer device of the first customer;
prompting, via a processing device, the customer device to display the plurality of available account management models;
receiving, via a processing device, from the customer device, an indication that the first customer has selected a first account management model from the plurality of available account management models; and
applying, via a processing device, the first account management model to assets of the first customer.

16. The computer implemented method of claim 15, wherein the life event comprises one of an engagement, a marriage, a wedding, a common law marriage, or a cohabitation with another individual.

17. The computer implemented method of claim 15, said computer implemented method further comprising:
identifying, via a processing device, a second customer;
retrieving, via a processing device, a second set of customer data, wherein the second set of customer data comprises the second customer's social media data, transaction data, search history data, and customer information;
determining, via a processing device, the plurality of available account management models based on the predicted occurrence of the life event, the first set of customer data, and the second set of customer data; and
applying, via a processing device, the first account management model to the assets of the first customer and to the assets of the second customer.

18. The computer program product of claim 17, wherein identifying the second customer comprises:
prompting, via a processing device, the customer device of the first customer to request an identity of the second customer, wherein the second customer is associated with the predicted life event; and
retrieving, via a processing device, from the customer device, a response from the first customer comprising the identity of the second customer.

19. The computer program product of claim 17, wherein identifying the second customer comprises determining, via a processing device, the identity of the second customer from the first set of customer data associated with the predicted life event.

20. The computer program product of claim 15, wherein applying the first account management model to the assets of the first customer further comprises:
prompting, via a processing device, the customer device to display a selectable calendar and a request for an account management model conversion date to the first customer;
receiving, via a processing device, from the customer device, a selected account management model conversion date from the first customer; and
applying, via a processing device, the first account management model to the assets of the first customer on the selected account management model conversion date.
